(19) United States
(12) Patent Application Publication
(10) Pub. No.: US 2025/0180346 A1
(43) Pub. Date: Jun. 5, 2025

(54) ELONGATED MEMBER, DETECTION SYSTEM, AND MOTION MECHANISM

(71) Applicant: TOYOTA JIDOSHA KABUSHIKI KAISHA, Toyota-shi (JP)

(72) Inventor: Kento INUZUKA, Toyota-shi (JP)

(73) Assignee: TOYOTA JIDOSHA KABUSHIKI KAISHA, Toyota-shi (JP)

(21) Appl. No.: 18/527,527

(22) Filed: Dec. 4, 2023

(30) Foreign Application Priority Data
Feb. 17, 2023 (JP) 2023-023326

(51) Int. Cl. G01B 11/04

(52) U.S. Cl. CPC G01B 11/043

(57) ABSTRACT

An elongated member is used for a detection system that detects an amount of displacement that is an amount the elongated member is reeled out or reeled in in a motion mechanism in which a moving part moves as the elongated member is reeled out or reeled in. The elongated member includes a main body part and a patterned part in which a plurality of reflective portions appears in a surface of the main body part. The plurality of reflective portions each has different reflection characteristics relative to an electromagnetic wave applied to the elongated member.

### CROSS-REFERENCE TO RELATED APPLICATION

This application claims priority to Japanese Patent Application No. 2023-023326 filed on Feb. 17, 2023 incorporated herein by reference in its entirety.

### BACKGROUND

### 1. Technical Field

This disclosure relates to an elongated member, a detection system, and a motion mechanism, and relates to, for example, an elongated member used for a detection system that detects an amount of displacement that is an amount the elongated member is reeled out or reeled in in a motion mechanism in which a moving part moves as the elongated member is reeled out or reeled in, a detection system, and a motion mechanism.

### 2. Description of Related Art

For example, Japanese Patent No. 6874640 discloses a mechanism in which a wire is reeled out and reeled in by a motor to thereby assist a trainee in walking motion. Such a motion mechanism in which a moving part moves as a wire is reeled out and reeled in by a motor calculates an amount of displacement of the wire by an encoder provided in the motor.

### SUMMARY

As in a common motion mechanism in which a moving part moves as an elongated member, such as a wire, is reeled out and reeled in by a motor, the influence of stretching of the elongated member etc. is not taken into account when calculating an amount of displacement of the elongated member by the encode provided in the motor. As a result, error in the motion of the moving part may occur.

This disclosure provides an elongated member and a detection system that can mitigate the influence of stretching of the elongated member on the motion of a moving part in a motion mechanism, and a motion mechanism using this detection system.

An elongated member according to one aspect of this disclosure is used for a detection system that detects an amount of displacement that is an amount the elongated member is reeled out or reeled in in a motion mechanism in which a moving part moves as the elongated member is reeled out or reeled in. The elongated member includes a main body part and a patterned part in which a plurality of reflective portions appears in a surface of the main body part. The plurality of reflective portions each has different reflection characteristics relative to an electromagnetic wave applied to the elongated member.

A detection system according to one aspect of this disclosure includes: the above-described elongated member; an irradiation unit configured to apply an electromagnetic wave to the patterned part; a sensor unit configured to detect a reflected wave of the electromagnetic wave applied to the patterned part; and a calculation unit configured to calculate, based on a difference in reflection characteristics among reflective portions of the patterned part that has been detected by the sensor unit, an amount of displacement that is an amount the elongated member is reeled out or reeled in in a motion mechanism in which a moving part moves as the elongated member is reeled out or reeled in.

In the above-described detection system, the irradiation unit may be configured to apply visible light to the elongated member.

In the above-described detection system, the sensor unit may be configured to detect each of reflected waves in different wavelength ranges.

In the above-described detection system, the sensor unit may include:
a first sensor configured to detect a reflected wave in a red wavelength range;
a second sensor configured to detect a reflected wave in a blue wavelength range; and
a third sensor configured to detect a reflected wave in a green wavelength range.

In the above-described detection system, the calculation unit may be configured to acquire a detection result of the sensor unit for each of the reflective portions, and may be configured to calculate the amount of displacement of the elongated member according to a combination of wavelength ranges of detected reflected waves.

In the above-described detection system, the patterned part may include a plurality of sets of reflective portions in a repetitive arrangement, with each set composed of a plurality of reflective portions each having a different color.

In the above-described detection system, the different color may be one color among red, blue, and green, a color combining two or more colors among red, blue, and green, or black.

In the above-described detection system, the elongated member may be a wire rod made of a flexible material or the wire rods twisted together.

A motion mechanism according to one aspect of this disclosure includes: the above-described detection system; a moving part configured to move based on displacement of the elongated member; a fixed part on which the moving part is fixed; and a driving part that is provided in the fixed part and configured to reel out or reel in the elongated member. The irradiation unit and the sensor unit of the detection system are disposed closer to a junction between the elongated member and the moving part than to the driving part.

According to this disclosure, an elongated member and a detection system that can mitigate the influence of stretching of the elongated member on the motion of a moving part in a motion mechanism, and a motion mechanism using this detection system can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing the configuration of a motion mechanism of an embodiment;

FIG. 2 is a block diagram showing the configuration of a control system of the motion mechanism of the embodiment;

FIG. 3 is a view for description including that of detection timings of sensors relative to reflective portions of a patterned part of a wire in a detection system used for the motion mechanism of the embodiment;

FIG. 4 is a view for description of arrangement of light sources and the sensors in the detection system used for the motion mechanism of the embodiment;

FIG. 5 is a flowchart showing the flow of calculation of an amount of displacement of the wire in the detection system used for the motion mechanism of the embodiment; and

FIG. 6 is a flowchart showing the flow of acquiring a Gray code in the detection system used for the motion mechanism of the embodiment.

### DETAILED DESCRIPTION OF EMBODIMENTS

A specific embodiment to which this disclosure is applied will be described in detail below with reference to the drawings. It is not that this disclosure is limited to the following embodiment. The following description and the drawings are simplified as appropriate.

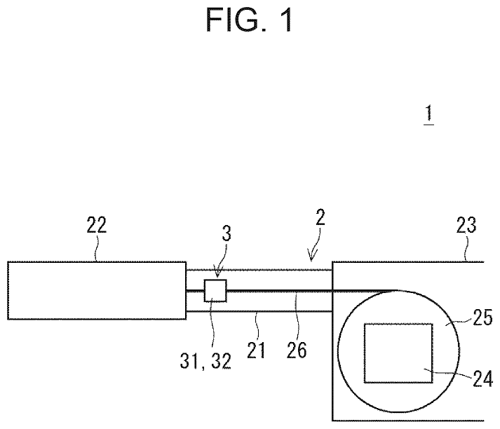

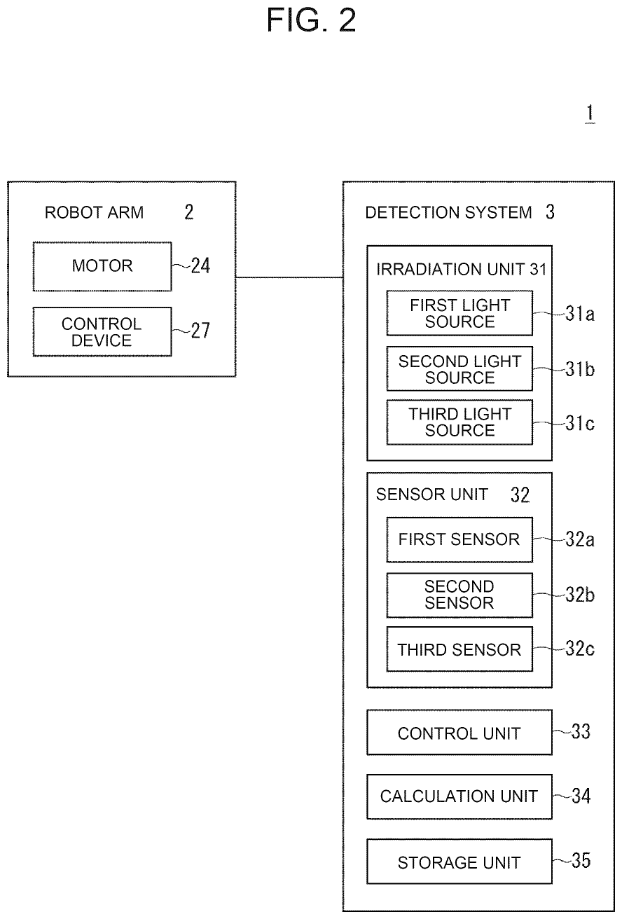

First, the configuration of a motion mechanism of the embodiment will be described. FIG. 1 is a schematic view showing the configuration of the motion mechanism of the embodiment. FIG. 2 is a block diagram showing the configuration of a control system of the motion mechanism of the embodiment. For example, as shown in FIG. 1 and FIG. 2, a motion mechanism 1 of the embodiment includes a robot arm 2 and a detection system 3.

For example, as shown in FIG. 1, the robot arm 2 has a configuration in which a hand (one example of the moving part) 22 is connected to a leading end portion of an arm main body 21 and a base portion of the arm main body 21 is connected to a fixed part 23. The robot arm 2 is configured such that the hand 22 moves as a rotary driving force of a motor (one example of the driving part) 24 fixed in the fixed part 23 is transmitted to a pulley 25 and a wire 26 wound around the pulley 25 is thereby reeled out or reeled in.

In this case, as shown in FIG. 2, the motor 24 is controlled by a control device 27 based on a detection result of the detection system 3. While the motion mechanism 1 of the embodiment includes the robot arm 2, the motion mechanism 1 may be any mechanism in which a moving part moves as an elongated member, such as a wire, is reeled out or reeled in.

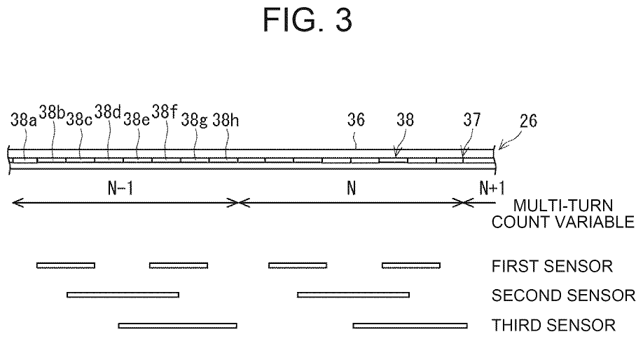

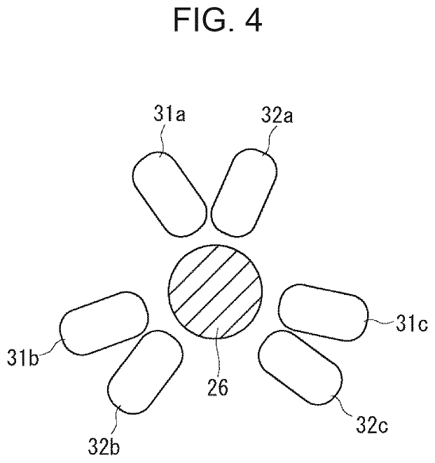

FIG. 3 is a view for description including that of detection timings of sensors relative to reflective portions of a patterned part of a wire in the detection system used for the motion mechanism of the embodiment. FIG. 4 is a view for description of arrangement of light sources and the sensors in the detection system used for the motion mechanism of the embodiment. In FIG. 3, depiction of coloration of the reflective portions is omitted.

As shown in FIG. 1, FIG. 2, etc., the detection system 3 includes, other than the above-described wire 26, an irradiation unit 31, a sensor unit 32, a control unit 33, a calculation unit 34, and a storage unit 35. For example, as shown in FIG. 3, the wire 26 includes a main body part 36 and a patterned part 37. The main body part 36 is a wire rod made of metal or a flexible material, such as an elastic body, or is an elongated member formed by twisting wire rods together.

The patterned part 37 is provided in the wire 26, for example, such that a plurality of reflective portions 38 appears in a regular repetition in a surface of the main body part 36 of the wire 26. The plurality of reflective portions 38 each has a different reflection characteristics relative to electromagnetic waves applied to the wire 26. For example, the patterned part 37 preferably has a plurality of sets of the reflective portions 38 in repetitive arrangement, with each set composed of the plurality of reflective portions 38, each having a 10 different color, arrayed in the same manner.

For example, as shown in FIG. 3, the patterned part 37 includes, as the plurality of reflective portions 38, a black first reflective portion 38a, a red second reflective portion 38b, a violet third reflective portion 38c, a blue fourth reflective portion 38d, a light blue fifth reflective portion 38e, a white sixth reflective portion 38f, a yellow seventh reflective portion 38g, and a green eighth reflective portion 38h.

Thus, the first to eighth reflective portions 38a, 38b, 38c, 38d, 38c, 38f, 38g, 38h have a color that can be formed by combining red, blue, and green, or a color that can be formed by not combining red, blue, and green (e.g., black). Such a color is, for example, one color among red, blue, and green, a color combining two or more colors among red, blue, and green, or black.

With these first to eighth reflective portions 38a, 38b, 38c, 38d, 38e, 38f, 38g, 38h as one set, a plurality of sets is arranged in a repetitive manner in an axial direction of the wire 26. Accordingly, the first to eighth reflective portions 38a, 38b, 38c, 38d, 38e, 38f, 38g, 38h appear in the surface of the main body part 36 of the wire 26 in a regular repetition.

For example, the first to eighth reflective portions 38a, 38b, 38c, 38d, 38e, 38f, 38g, 38h preferably each have a substantially equal length, say, about 0.1 to 1 mm, in the axial direction of the main body part 36 of the wire 26. However, the number and the length of the reflective portions 38 can be changed as appropriate according to the wavelength range of electromagnetic waves that the irradiation unit 31 can emit, the wavelength range in which the sensor unit 32 can detect, etc.

Such a patterned part 37 can be formed by, for example, applying paints to the surface of the main body part 36 of the wire 26. As long as the patterned part 37 is provided in the wire 26 so as to appear in the surface of the main body part 36 of the wire 26, the patterned part 37 may be formed by, for example, paints contained in the material of the wire 26. That is, at a minimum, the patterned part 37 should be fixed on the main body part 36 of the wire 26.

For example, the patterned part 37 is arranged preferably over an entire region of the main body part 36 of the wire 26 in the axial direction. For example, the patterned part 37 is arranged preferably over an entire region of the main body part 36 of the wire 26 in a circumferential direction. At a minimum, the patterned part 37 should be disposed in the surface of the main body part 36 of the wire 26 such that, when the wire 26 is reeled out or reeled in, the irradiation unit 31 can apply electromagnetic waves to the patterned part 37 as well as the sensor unit 32 can detect reflected waves.

The irradiation unit 31 applies electromagnetic waves to the patterned part 37 of the wire 26. The irradiation unit 31 applies, for example, visible light to the patterned part 37 of the wire 26. In this case, for example, the irradiation unit 31 is preferably controlled so as to apply light to the reflective portions 38 of the patterned part 37 of the wire 26, at least once for each reflective portion 38. Alternatively, the irradiation unit 31 may be controlled so as to continuously apply light to the patterned part 37 of the wire 26.

For example, as shown in FIG. 2 and FIG. 4, the irradiation unit 31 includes a first light source 31a, a second light source 31b, and a third light source 31c. The first light source 31a, the second light source 31b, and the third light source 31c include, for example, a laser diode or a light emitting diode (LED) that can emit visible light, and, as shown in FIG. 4, are arranged at substantially equal intervals in the circumferential direction of the wire 26. Thus, the irradiation unit 31 can apply light to an entire circumference of the main body part 36 of the wire 26.

As shown in FIG. 1, the first light source 31a, the second light source 31b, and the third light source 31c are preferably disposed near a junction between the hand 22 of the robot arm 2 and the wire 26, i.e., closer to the junction between the hand 22 and the wire 26 than to the motor 24, and fixed on the arm main body 21.

The sensor unit 32 detects each of reflected waves in different wavelength ranges. For example, as shown in FIG. 2 and FIG. 4, the sensor unit 32 preferably includes a first sensor 32a that detects reflected light in a red wavelength range, a second sensor 32b that detects reflected light in a blue wavelength range, and a third sensor 32c that detects reflected light in a green wavelength range.

These first sensor 32a, second sensor 32b, and third sensor 32c include, for example, a light receiving element, and is preferably controlled such that data of the light receiving element is read for each reflective portion 38 of the patterned part 37 of the wire 26. As shown in FIG. 4, the first sensor 32a, the second sensor 32b, and the third sensor 32c are arranged at substantially equal intervals in the circumferential direction of the main body part 36 of the wire 26.

In this case, as shown in FIG. 4, each pair of the first light source 31a and the first sensor 32a, the second light source 31b and the second sensor 32b, and the third light source 31c and the third sensor 32c is arranged preferably next to each other in the circumferential direction of the main body part 36 of the wire 26.

Thus, the accuracy with which the first sensor 32a detects reflected light of light emitted by the first light source 31a improves, and the accuracy with which the second sensor 32b detects reflected light of light emitted by the second light source 31b improves. Further, the accuracy with which the third sensor 32c detects reflected light of light emitted by the third light source 31c improves.

As shown in FIG. 1, the first sensor 32a, the second sensor 32b, and the third sensor 32c are arranged preferably near the junction between the hand 22 of the robot arm 2 and the wire 26, i.e., closer to the junction between the hand 22 and the wire 26 than to the motor 24, and fixed on the arm main body 21.

The control unit 33 controls timings at which the first light source 31a, the second light source 31b, and the third light source 31c emit light, and timings at which data of the light receiving elements of the first sensor 32a, the second sensor 32b, and the third sensor 32c is read.

As will be described in detail later, the calculation unit 34 calculates an amount of displacement of the wire 26 based on a detection result of the sensor unit 32. That is, for example, the calculation unit 34 preferably acquires data of the light receiving elements of the first sensor 32a, the second sensor 32b, and the third sensor 32c that has been read for each reflective portion 38 of the patterned part 37 of the wire 26, and calculate the amount of displacement of the wire 26 according to the combination of the wavelength ranges of the detected reflected light in the respective pieces of data.

The storage unit 35 stores data of the light receiving elements of the first sensor 32a, the second sensor 32b, and the third sensor 32c that has been read for each reflective portion 38 of the patterned part 37 of the wire 26; position data, calculated by the calculation unit 34 last time, on a reflective portion 38 to which the first light source 31a, the second light source 31b, and the third light source 31c have applied light among the first to eighth reflective portions 38a, 38b, 38c, 38d, 38c, 38f, 38g, 38h; the last multi-turn count variable data; absolute position data on the reflective portion 38 in the wire 26 calculated by the calculation unit 34 this time; an original position of the wire 26 that is set in advance; and other pieces of data.

Next, detection timings will be described at which the first sensor 32a, the second sensor 32b, and the third sensor 32c detect light in the respective wavelength ranges relative to the first to eighth reflective portions 38a, 38b, 38c, 38d, 38c, 38f, 38g, 38h of the patterned part 37 of the wire 26 in the detection system 3 used for the motion mechanism 1 of the embodiment.

When the first light source 31a, the second light source 31b, and the third light source 31c apply light to the first reflective portion 38a, as the first reflective portion 38a is black, it does not reflect light in the red wavelength range, light in the blue wavelength range, and light in the green wavelength range. Therefore, as shown in FIG. 3, the first sensor 32a, the second sensor 32b, and the third sensor 32c do not detect reflected light.

When the first light source 31a, the second light source 31b, and the third light source 31c apply light to the second reflective portion 38b, as the second reflective portion 38b is red, it reflects light in the red wavelength range but does not reflect light in the blue wavelength range and light in the green wavelength range. Therefore, as shown in FIG. 3, the first sensor 32a detects reflected light while the second sensor 32b and the third sensor 32c do not detect reflected light.

When the first light source 31a, the second light source 31b, and the third light source 31c apply light to the third reflective portion 38c, as the third reflective portion 38c is violet, it reflects light in the red wavelength range and light in the blue wavelength range but does not reflect light in the green wavelength range. Therefore, as shown in FIG. 3, the first sensor 32a and the second sensor 32b detect reflected light while the third sensor 32c does not detect reflected light.

When the first light source 31a, the second light source 31b, and the third light source 31c apply light to the fourth reflective portion 38d, as the fourth reflective portion 38d is blue, it reflects light in the blue wavelength range but does not reflect light in the red wavelength range and light in the green wavelength range. Therefore, as shown in FIG. 3, the second sensor 32b detects reflected light while the first sensor 32a and the third sensor 32c do not detect reflected light.

When the first light source 31a, the second light source 31b, and the third light source 31c apply light to the fifth reflective portion 38e, as the fifth reflective portion 38e is light blue, it reflects light in the blue wavelength range and light in the green wavelength range but does not reflect light in the red wavelength range. Therefore, as shown in FIG. 3, the second sensor 32b and the third sensor 32c detect reflected light while the first sensor 32a does not detect reflected light.

When the first light source 31a, the second light source 31b, and the third light source 31c apply light to the sixth reflective portion 38f, as the sixth reflective portion 38f is white, it reflects light in the red wavelength range, light in the blue wavelength range, and light in the green wavelength range. Therefore, as shown in FIG. 3, the first sensor 32a, the second sensor 32b, and the third sensor 32c detect reflected light.

When the first light source 31a, the second light source 31b, and the third light source 31c apply light to the seventh reflective portion 38g, as the seventh reflective portion 38g is yellow, it reflects light in the red wavelength range and light in the green wavelength range but does not reflect light in the blue wavelength range. Therefore, as shown in FIG. 3, the first sensor 32a and the third sensor 32c detect reflected light while the second sensor 32b does not detect reflected light.

When the first light source 31a, the second light source 31b, and the third light source 31c apply light to the eighth reflective portion 38h, as the eighth reflective portion 38h is green, it reflects light in the green wavelength range but does not reflect light in the red wavelength range and light in the blue wavelength range. Therefore, as shown in FIG. 3, the third sensor 32c detects reflected light while the first sensor 32a and the second sensor 32b do not detect reflected light.

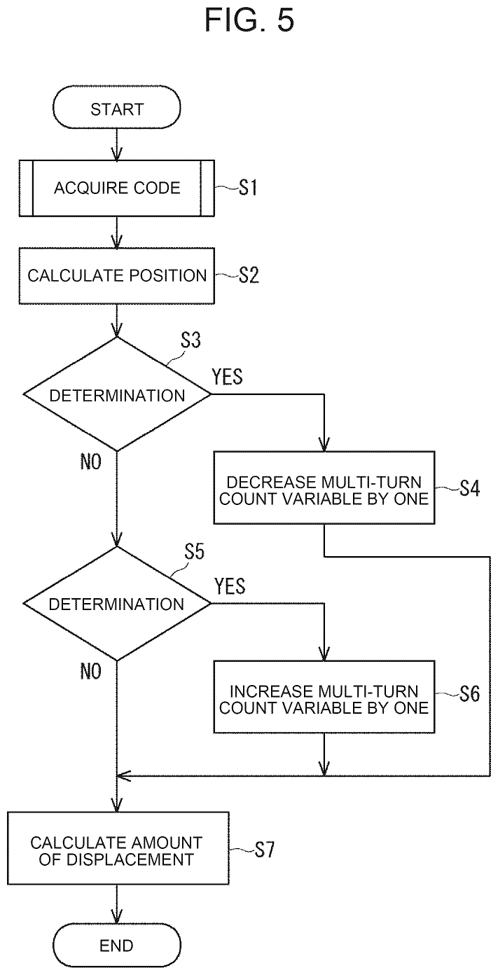

Next, the flow of calculating the amount of displacement of the wire 26 in the detection system 3 used for the motion mechanism 1 of the embodiment will be described. FIG. 5 is a flowchart showing the flow of calculating the amount of displacement of the wire 26 in the detection system 3 used for the motion mechanism 1 of the embodiment.

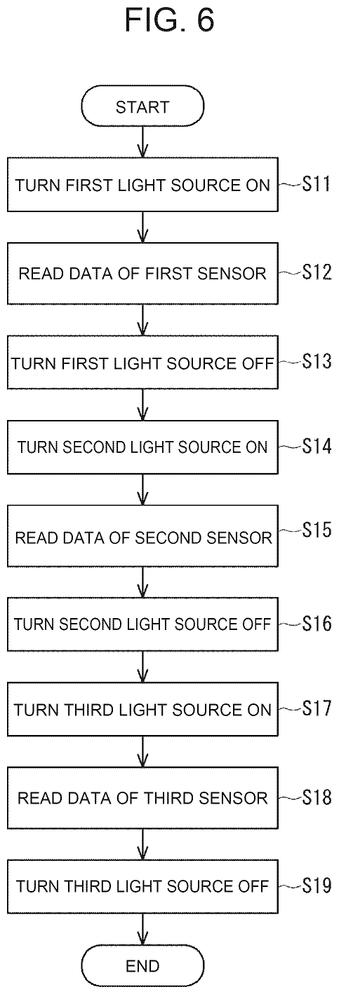

First, the calculation unit 34 acquires a Gray code (S1). FIG. 6 is a flowchart showing the flow of acquiring a Gray code in the detection system 3 used for the motion mechanism 1 of the embodiment.

Specifically, first, the control unit 33 controls the first light source 31a to apply light to a reflective portion 38 of the patterned part 37 of the wire 26 (S11). Next, the control unit 33 controls the first sensor 32a to read data of the light receiving element of the first sensor 32a (S12). Then, the control unit 33 controls the first light source 31a so as to turn off (S13).

Next, the control unit 33 controls the second light source 31b to apply light to the same reflective portion 38 in the patterned part 37 of the wire 26 as the reflective portion 38 to which the first light source 31a has applied light (S14). Next, the control unit 33 controls the second sensor 32b to read data of the light receiving element of the second sensor 32b (S15). Then, the control unit 33 controls the second light source 31b so as to turn off (S16).

Next, the control unit 33 controls the third light source 31c to apply light to the same reflective portion 38 in the patterned part 37 of the wire 26 as the reflective portion 38 to which the first light source 31a and the second light source 31b have applied light (S17). Next, the control unit 33 controls the third sensor 32c to read data of the light receiving element of the third sensor 32c (S18). Then, the control unit 33 controls the third light source 31c so as to turn off (S19).

In this case, the calculation unit 34 can generate a Gray code according to the combination of detection timings at which the first sensor 32a, the second sensor 32b, and the third sensor 32c detect light in the respective wavelength ranges as described above, i.e., the combination of the wavelength ranges of the detected reflected light.

For example, for the first reflective portion 38a, where the first sensor 32a, the second sensor 32b, and the third sensor 32c do not detect reflected light, the calculation unit 34 can acquire a Gray code “000.” For the second reflective portion 38b, where the first sensor 32a detects reflected light while the second sensor 32b and the third sensor 32c do not detect reflected light, the calculation unit 34 can acquire a Gray code “100.”

For example, for the third reflective portion 38c, where the first sensor 32a and the second sensor 32b detect reflected light while the third sensor 32c does not detect reflected light, the calculation unit 34 can acquire a Gray code “110.”

For example, for the fourth reflective portion 38d, where the second sensor 32b detects reflected light while the first sensor 32a and the third sensor 32c do not detect reflected light, the calculation unit 34 can acquire a Gray code “010.”

For example, for the fifth reflective portion 38e, where the second sensor 32b and the third sensor 32c detect reflected light while the first sensor 32a does not detect reflected light, the calculation unit 34 can acquire a Gray code “011.” For example, for the sixth reflective portion 38f, where the first sensor 32a, the second sensor 32b, and the third sensor 32c detect reflected light, the calculation unit 34 can acquire a Gray code “111.”

For example, for the seventh reflective portion 38g, where the first sensor 32a and the third sensor 32c detect reflected light while the second sensor 32b does not detect reflected light, the calculation unit 34 can acquire a Gray code “101.”

For example, for the eighth reflective portion 38h, where the third sensor 32c detects reflected light while the first sensor 32a and the second sensor 32b do not detect reflected light, the calculation unit 34 can acquire a Gray code “001.” In this case, the reflective portions 38 are arranged preferably such that when the Gray code changes between adjacent reflective portions 38, no two digits change at the same time.

Next, the calculation unit 34 converts the acquired Gray code into a binary code, and calculates the position of the reflective portion 38 among the first to eighth reflective portions 38a, 38b, 38c, 38d, 38c, 38f, 38g, 38h to which the first light source 31a, the second light source 31b, and the third light source 31c have applied light (this may be hereinafter simply abbreviated to “the position of the reflective portion 38”) (S2).

Next, the calculation unit 34 determines whether the position of the reflective portion 38 calculated last time is the first reflective portion 38a and moreover the position of the reflective portion 38 calculated this time is the eighth reflective portion 38h (S3).

When the position of the reflective portion 38 calculated last time is the first reflective portion 38a and moreover the position of the reflective portion 38 calculated this time is the eighth reflective portion 38h (YES in S3), the calculation unit 34 decreases the multi-turn count variable by one (S4). For example, when the last multi-turn count variable is N (N is an integer not smaller than one), the calculation unit 34 sets the current multi-turn count variable to N−1.

On the other hand, when the position of the reflective portion 38 calculated last time is the first reflective portion 38a and moreover the position of the reflective portion 38 calculated this time is not the eighth reflective portion 38h (NO in S3), the calculation unit 34 determines whether the position of the reflective portion 38 calculated last time is the eighth reflective portion 38h and moreover the position of the reflective portion 38 calculated this time is the first reflective portion 38a (S5).

When the position of the reflective portion 38 calculated last time is the eighth reflective portion 38h and moreover the position of the reflective portion 38 calculated this time is the first reflective portion 38a (YES in S5), the calculation unit 34 increases the multi-turn count variable by one (S6). For example, when the last multi-turn count variable is N, the calculation unit 34 sets the current multi-turn count variable to N+1.

On the other hand, when the position of the reflective portion 38 calculated last time is the eighth reflective portion 38h and moreover the position of the reflective portion 38 calculated this time is not the first reflective portion 38a (NO in S5), the calculation unit 34 calculates the amount of displacement of the wire 26 relative to its original position based on the calculated position data on the reflective portion 38 and the last multi-turn count variable data (S7). The original position is the position of the wire 26 that is set in advance, for example, the position of the reflective portion 38 to which the irradiation unit 31 applies light when the hand 22 is in a predetermined state. That is, the calculation unit 34 calculates the amount of displacement of the absolute position of the reflective portion 38 within the wire 26 relative to the original position of the wire 26.

Alternatively, after the process of S4 or the process of S6, the calculation unit 34 calculates the amount of displacement of the wire 26 relative to its original position based on the calculated position data on the reflective portion 38 and the current multi-turn count variable data calculated in the process of S4 or the process of S6 (S7).

Thereafter, the calculation unit 34 stores, in the storage unit 35, the position data on the reflective portion 38 and the multi-turn count variable data that have been used to calculate the amount of displacement of the wire 26 relative to its original position, as the position data on the reflective portion 38 calculated last time and the multi-turn count variable data.

Thus, in the wire 26, the detection system 3, and the motion mechanism 1 of the embodiment, the patterned part 37 is provided in the wire 26 for moving the hand 22 that is the moving part of the motion mechanism 1, and the amount of displacement of the wire 26 is detected based on reflection of electromagnetic waves applied to this patterned part 37. In this case, unlike a common encoder, the irradiation unit 31 and the sensor unit 32 can be arranged closer to the junction between the hand 22 and the wire 26 than to the motor 24.

Compared with the length of a wire between a common encoder and a moving part, the length of the wire 26 between the irradiation unit 31 and the sensor unit 32 on one side and the hand 22 on the other side is shorter. Therefore, compared with a common encoder, the amount of displacement of the wire 26 can be detected at a point where the influence of stretching of the wire 26 on the motion of the hand 22 is smaller. Thus, the wire 26 and the detection system 3 can be applied to the motion mechanism 1 so as to mitigate the influence of stretching of the wire 26 on the motion of the hand 22.

This disclosure is not limited to the above-described embodiment but can be changed as appropriate within the scope of the gist of the disclosure.

For example, the irradiation unit 31 of the above-described embodiment includes the first light source 31a, the second light source 31b, and the third light source 31c, but the number of the light sources can be changed as appropriate, and there may be, for example, one light source.

For example, the irradiation unit 31 of the above-described embodiment is configured to emit visible light. The first light source 31a, the second light source 31b, and the third light source 31c may simultaneously emit light in the red wavelength range, light in the blue wavelength range, and light in the green wavelength range, respectively.

For example, the sensor unit 32 of the above-described embodiment includes the first sensor 32a, the second sensor 32b, and the third sensor 32c, but the number of the sensors can be changed as appropriate. For example, the sensor unit 32 may include one or more color sensors that can detect red, blue, and green light.

For example, in the above-described embodiment, the amount of displacement of the wire 26 is detected using light in the red wavelength range, light in the blue wavelength range, and light in the green wavelength range. At a minimum, the amount of displacement of the wire 26 should be detected using electromagnetic waves in a plurality of different wavelength ranges.

For example, in the above-described embodiment, the first to eighth reflective portions 38a, 38b, 38c, 38d, 38c, 38f, 38g, 38h are arranged in a regular repetition, but the plurality of reflective portions may be irregularly arranged in terms of the shape, length, pattern, etc., within such a range that the reproducibility of repetition is not lost. Further, all the reflective portions may have different reflection characteristics. In these cases, for example, as long as what reflection is detected at each position is known in advance, the position of the reflective portion can be calculated through, for example, a comparison between a detection result and stored data such as a template of a reflection pattern etc. and the ratio of a reflection wavelength for each position (e.g., through a calculation of a correlation value).

What is claimed is:

1. An elongated member used for a detection system that detects an amount of displacement that is an amount the elongated member is reeled out or reeled in in a motion mechanism in which a moving part moves as the elongated member is reeled out or reeled in, the elongated member comprising:
a main body part; and
a patterned part in which a plurality of reflective portions appears in a surface of the main body part, wherein
the plurality of reflective portions each has different reflection characteristics relative to an electromagnetic wave applied to the elongated member.

2. A detection system comprising:
the elongated member according to claim 1;
an irradiation unit configured to apply an electromagnetic wave to the patterned part;
a sensor unit configured to detect a reflected wave of the electromagnetic wave applied to the patterned part; and
a calculation unit configured to calculate, based on a difference in reflection characteristics among reflective portions of the patterned part that has been detected by the sensor unit, an amount of displacement that is an amount the elongated member is reeled out or reeled in in a motion mechanism in which a moving part moves as the elongated member is reeled out or reeled in.

3. The detection system according to claim 2, wherein the irradiation unit is configured to apply visible light to the elongated member.

4. The detection system according to claim 2, wherein the sensor unit is configured to detect each of reflected waves in different wavelength ranges.

5. The detection system according to claim 4, wherein the sensor unit includes:
a first sensor configured to detect a reflected wave in a red wavelength range;
a second sensor configured to detect a reflected wave in a blue wavelength range; and
a third sensor configured to detect a reflected wave in a green wavelength range.

6. The detection system according to claim 4, wherein the calculation unit is configured to acquire a detection result of the sensor unit for each of the reflective portions, and is configured to calculate the amount of displacement of the elongated member according to a combination of wavelength ranges of detected reflected waves.

7. The detection system according to claim 2, wherein the patterned part includes a plurality of sets of reflective portions in a repetitive arrangement, with each set composed of a plurality of reflective portions each having a different color.

8. The detection system according to claim 7, wherein the different color is one color among red, blue, and green, a color combining two or more colors among red, blue, and green, or black.

9. The detection system according to claim 2, wherein the elongated member is a wire rod made of a flexible material or the wire rods twisted together.

10. A motion mechanism comprising:
the detection system according to claim 2;
a moving part configured to move based on displacement of the elongated member;
a fixed part on which the moving part is fixed; and
a driving part that is provided in the fixed part and configured to reel out or reel in the elongated member, wherein
the irradiation unit and the sensor unit of the detection system are disposed closer to a junction between the elongated member and the moving part than to the driving part.
